(19) United States
(12) Patent Application Publication
(10) Pub. No.: US 2012/0307619 A1
(43) Pub. Date: Dec. 6, 2012

(54) OPTICAL PICKUP DEVICE

(75) Inventors: Rika NOMURA, Yokohama (JP); Taketoshi Moriyama, Fujisawa (JP)

(73) Assignee: Hitachi Media Electronics Co., Ltd.

(21) Appl. No.: 13/483,086

(22) Filed: May 30, 2012

(30) Foreign Application Priority Data
May 30, 2011 (JP) 2011-120232

(51) Int. Cl. G11B 7/12

(52) U.S. Cl. 369/100; G9B/7.097

(57) ABSTRACT

An optical pickup device, which is capable of inhibiting peeling from a bonded interface and deviation of an optical axis from being caused even by long-term environmental variations, has a photonic device 1, a flexible printed substrate 2, a holding member 3, an optical pickup case 5 and a bonding connection 4 for bonding the holding member 3 and the optical pickup case 5 together. The adhesive enters an inside of the optical pickup case. The adhesive has a cross-sectional area on the outer surface of the optical pickup case in communication with the inside smaller than a cross-sectional area in the inside of the optical pickup case.

### CLAIM OF PRIORITY

The present application claims priority from Japanese patent application JP 2011-120232 filed on May 30, 2011, the content of which is hereby incorporated by reference into this application.

### BACKGROUND OF THE INVENTION

1. Field of the Invention

This invention relates to an optical pickup device used to read and write an optical recording medium such as a CD (Compact Disc), a DVD (Digital Versatile Disc), a BD (Blu-ray Disc) or the like.

2. Description of the Related Art

An optical pickup device used to write and read an optical recording medium such as a CD, a DVD or a BD, or alternatively an optical disc drive incorporating the optical pickup device includes an optical system for guiding light emitted by a light emitting device such as a laser diode, through various lenses, prisms, mirrors and the like to an objective lens so as to be converge the light to an optical recording medium, and another optical system for causing an opto-electronic transducer to receive the return light from the optical recording medium through the objective lens, various lenses, prisms and the mirrors for conversion of the optical output to an electric signal. In this structure, in the process of fixed bonding between a case of an optical pickup and an optics module in which a flexible printed substrate mounted with the optoelectronic transducer (hereinafter referred to as the “light-receiving device” such as photo diode) is fixed to a light-receiving device holder or a reinforcing plate, the light-receiving device is required to be secured to an optically optimum position of the case of the optical pickup by use of an adhesive. Because of this, for the fixed bonding of the optics module, either the front or the back of the optics module is bonded from the viewpoint of positional stability.

In Japanese Patent Application Laid-Open Publication No. 2009-146523, the position of a light-receiving-device mounting plate (holder) supporting the light-receiving device with respect to an optical base is adjusted such that the optical axis or the focus point of the reflected light reflected off the optical recording medium becomes aligned with the center of the light-receiving surface of the light-receiving device. And then, while the light-receiving-device mounting plate is in a horizontal position, equal amounts of adhesive are poured into recessed grooves which are located to create clearances between the light-receiving-device mounting plate and the optical base so that the two recessed grooves are filled with the adhesive in order to fixedly attach the light-receiving-device mounting plate to the optical base. It is possible to apply the adhesive in equal amount and in uniform shape to the individual recesses grooves. Because of this, the adhesives applied to the recesses grooves are identical with each other in the amount of contraction of the setting adhesive and the amount of change in expansion/contraction in response to changes in temperature, thus reducing the positional deviation of the light-receiving device.

Japanese Patent Application Laid-Open Publication No. 2007-298700 describes a lens supporting structure in which a lens is fixedly bonded with regard to structure for inhibiting peeling of an adhesive subjected to a thermal shock. The lens supporting structure includes a lens having an optically active area and a fixing area formed on the outer periphery of the optically active area, a supporting member located on the outer periphery of the lens for supporting the lens, and an adhesive disposed between the lens and the supporting member to secure the fixing area to the supporting member. The fixing area has a plurality of fixing surfaces which are formed on opposite sides in the optical-axis direction in such a manner as to face inward and at least a part of which is covered with the adhesive.

### SUMMARY OF THE INVENTION

The inventors have studied the bonding strength between the optics module and the optical pickup case with regard to long-term reliability. As a result, the inventors established that, when the front or the back of the optics module is bonded to the optical pickup case, because stress is easily placed directly on the bonded connection due to long-term environmental variations, this raises a disadvantage that, in particular, peeling gradually develops in the bonded interface between the optical pickup case and the adhesive so as to decrease the bonding strength, and a disadvantage of deviation of the optical axis. Accordingly, a required bonding fixing technique is for maintaining an optimum position with high positional precision without reducing the bonding strength when the front or the back of the optics module is bonded to the optical pickup case.

In Japanese Patent Application Laid-Open Publication No. 2009-146523, an optical pickup device using a high elastic modulus adhesive such as used to bond a photonic device has a high possibility that the adhesive peels off the bonding interface with the optical pickup case. In particular, if stress is applied due to long-term environmental variations, a reduction in bonding strength is conceivable. For reference sake, a low elastic modulus adhesive is soft so as to readily cause positional deviation, which therefore is not suitable for the bonding of the photonic device.

Japanese Patent Application Laid-Open Publication No. 2007-298700 is incapable of controlling an application position of the adhesive. For bonding of the light-receiving device, at least one portion or more of the front or the back of the optics module is fixedly bonding. Accordingly, a reduction in bonding strength and positional deviation of the light-receiving device may be possibly produced depending on an adhesive application position.

In light of the foregoing, for the purpose of ensuring the bonding reliability over the long term in the structure of securing an optics module including a light-receiving device and a holder or reinforcing plate supporting the light-receiving device to an optical pickup case by an adhesive, the optical pickup device is required to have a bonding structure capable of maintaining the bonding strength without peeling of the adhesive from the bonding interface even when the shearing, tensile moment is externally applied.

The present invention therefore provides an optical pickup device capable of inhibiting peeling of an adhesive from the bonded interface and deviation of an optical axis from being caused even by long-term environmental variations.

To attain this object, the present invention employs, for example, the structures and a manufacturing procedure described in “What is claimed is”. The present application includes a plurality of structures for addressing the technical problems in the related art. For example, an optical pickup device includes: a photonic device; a flexible printed substrate connected to the photonic device; a holding member supporting the photonic device and the flexible printed substrate; an optical pickup case; and an adhesive for bonding the holding member and the optical pickup case together. In the optical pickup device, the adhesive enters an inside of the optical pickup case. The adhesive has a cross-sectional area on the outer surface of the optical pickup case in communication with the inside smaller than a cross-sectional area in the inside of the optical pickup case.

According to an aspect of the present invention, in the optical pickup device, even if an optics module including a light-receiving device is bonded to the front or the back of an optical pickup case, interface peeling can be successfully inhibited from occurring due to long-term environmental variations and the bonding strength can be enhanced to the cohesion failure strength of the adhesive. This makes it possible to maintain an optimum position with high positional precision without reducing the bonding strength, resulting in an optical pickup device of steady quality.

### BRIEF DESCRIPTION OF THE DRAWINGS

FIG. 1 is a top view of an optics-module bonded connection in an optical pickup device according to a first embodiment of the present invention;

FIG. 2 is a side view of a case of an optical pickup of the optical pickup device according to the first embodiment of the present invention;

FIG. 3 is a sectional view of the optics-module bonded connection taken along the A-A′ line in FIG. 1 and FIG. 2;

FIG. 4 is a schematic diagram entirely illustrating the optical pickup device according to the first embodiment of the present invention;

FIGS. 5A and 5B are top views of optics-module bonded connections in an optical pickup device according to a second embodiment of the present invention;

FIGS. 6A and 6B are side views of cases of an optical pickup of an optical pickup device according to a third embodiment of the present invention;

FIGS. 7A to 7F are sectional views of optics-module bonded connection in an optical pickup device according to a fourth embodiment of the present invention, taken along the A-A′ line (corresponding to FIG. 3); and

FIG. 8 is a sectional view of an optics-module bonded connection in an optical pickup device according to a fifth embodiment of the present invention, taken along the A-A′ line (corresponding to FIG. 3).

### DETAILED DESCRIPTION OF THE INVENTION

Exemplary embodiments according to the present invention will be described below with reference to the accompanying drawings.

### First Embodiment

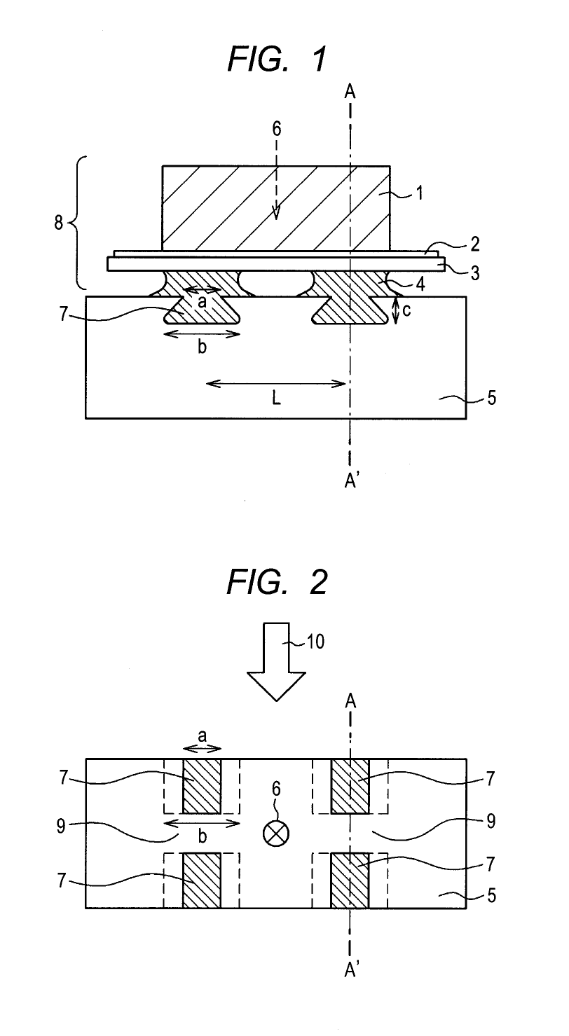

A first embodiment according to the present invention is described with reference to FIG. 1 to FIG. 4. The structure of an optical pickup device is described using FIG. 4. The embodiment describes using a light-receiving device as an example, but the present invention can be applied to any photonic device including a light-emitting device and the like. FIG. 4 is a schematic diagram of the overall structure when optics having functions as optical lenses, such as an optics module 8, a grating lens 11, a coupling lens 12, a detector lens 13 and the like, are fixedly bonded to an optical pickup case 5. The optics module 8 and the various lenses are moved downward in the direction of the arrow so as to be disposed in predetermined positions with respect to the optical axis of the optical pickup case 5. The optics module 8 and the optical pickup case 5 are bonded together by an adhesive applied to the front or the back of the optics module 8 which is parallel to the optical axis. Reference sign 100 denotes the structure of the optical pickup device. Reference sign 101 denotes the structure of an optical disc drive. The disc shown in an upper portion of FIG. 4 is an optical recording medium. The same reference signs denote the same components.

A material for a holder and a reinforcing plate of a light-receiving device of the optical pickup device is a die casting consisting essentially of Zn, Mg, Al, stainless steel, a press-molded workpiece or a printed wiring board mounted with the light-receiving device. An optical pickup case is preferably die castings and moldings consisting essentially of PPS (poly(phenylene sulfide)), PC (polycarbonate) and the like, but Zn, Mg, Al and the like may be used.

For adhesive materials for bonding the optical components to the optical pickup case, a high elastic modulus, acrylic-based or epoxy-based ultraviolet-cure adhesive or heat-cure adhesive is generally used.

It should be understood that the embodiment describes an optical pickup device including the foregoing structures, but the present invention can be applied to an optical pickup device using other metal materials, inorganic materials such as glass, resin, and/or adhesives.

Next, an overview of the embodiment will be described with reference to FIG. 1 to FIG. 3. FIG. 1 is a top view of a bonded connection between the optical pickup case 5 and the optics module 8 including a light-receiving device 1, a flexible printed substrate 2 connected to the light-receiving device 1 and a reinforcing plate 3 supporting the flexible printed substrate 2.

A bonding surface of the optics module 8 and the optical pickup case 5 includes the back of the optics module 8, which is secured to two positions of the optical pickup case 5 through bonding connections 4 fixed with an adhesive (hereinafter simply referred to as the “boding connection”). In the bonding surface, a bonding structure is formed such that recessed groove 7 is formed in the optical pickup case and the relationship between an opening length a of the recessed groove 7 and a longest length b of the bottom of the recessed groove becomes a<b. In other words, the adhesive enters the inside of the optical pickup case 5. The cross-sectional area of a portion of the adhesive located on the outer surface of the optical pickup case 5 is smaller than that of a portion of the adhesive located in the interior of the optical pickup case 5. With this bonding structure, even when the shearing, tensile moment is externally applied, stress is concentrated to the adhesive itself. For this reason, peeling from the bonded interface is able to be inhibited and prevented, so that the bonding strength is able to be maintained and enhanced to the cohesion failure strength of the adhesive. The recessed groove can be formed by use of a molding die including an upper die and a lower die. Reference sign 6 denotes the optical axis.

In the recessed groove of a triangular shape in cross section, even if the depth c of the recessed groove is reduced, the same advantageous effects can be produced. This makes it possible to maintain the bonding strength even in a thinned portion of the optical pickup case 5.

When the number of bonding connections 4 is two or more, bonding intervals L can be controlled to be held equal at all times by applying the adhesive to the recessed groove 7, thus inhibiting variations in bonding strength. When the optics module 8 and the optical pickup case 5 are fixedly bonded at the bonding intervals L of 2 millimeter<L<10 millimeter, a structure possessing high tensile strength results.

If the optics module 8 is attached to a holder and then the holder and the optical pickup case are bonded together at the front, the same advantageous effects can be produced.

FIG. 2 is a side view of the optical pickup case 5 in the bonding connections 4. The four recessed grooves 7 are formed in the bonding connections 4 of the optical pickup case 5 and arranged in a direction perpendicular to the optical axis 6 extending toward the light-receiving device. The adhesive is applied to the interiors of the recessed grooves 7. In the case illustrated in FIG. 2, a projection 9 is provided in the recessed groove 7 for forming closed grooves so as to provide the four closed grooves, but two through holes may be formed instead. In the case of the two through holes, the through holes are desirably arranged symmetrically about a diagonal line.

When the recessed groove 7 is machined in a direction perpendicular to an objective lens (not shown) of the optical pickup and an UV-cure adhesive is employed, the structure is desirably designed such that ultraviolet can be applied while curing the adhesive. Reference sign 10 denotes an external moment acting in the shearing direction.

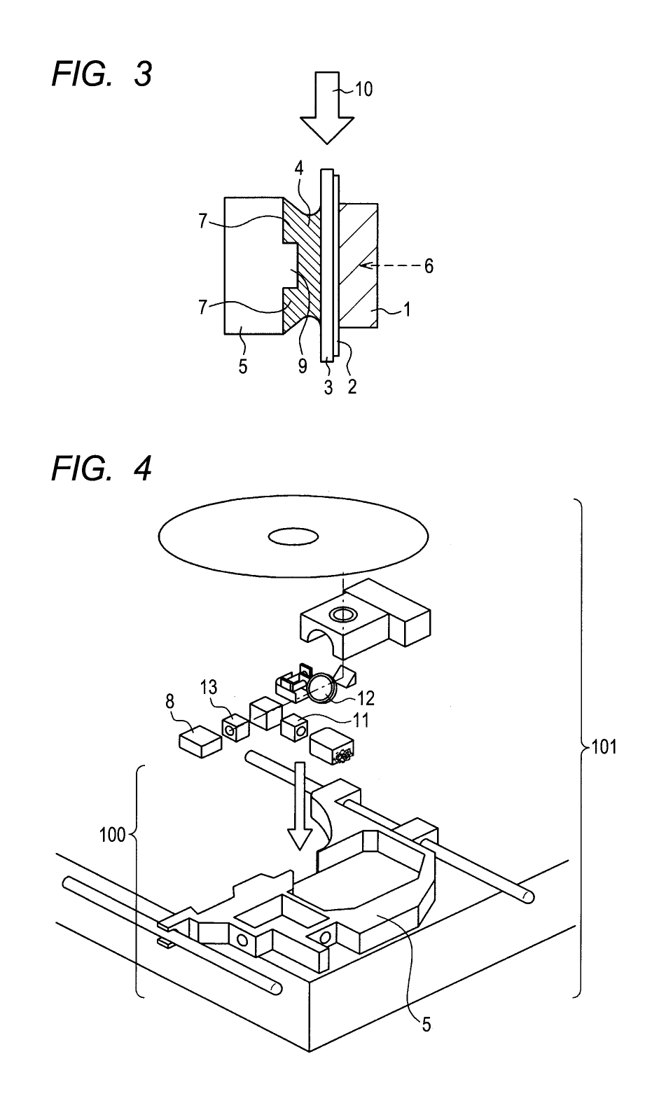

FIG. 3 is a sectional view taken along the A-A′ line in FIG. 1 and FIG. 2. A midpoint of the recessed groove 7 of the optical pickup case 5 corresponds to the projection 9 for forming the closed grooves. Accordingly, in the structure, if the moment 10 acts on the bonded connection 4 in the shearing direction, interface peeling from the optical pickup case 5 can be inhibited, so that the bonding strength can be enhanced to the cohesion failure strength of the adhesive. Unlike the optical pickup case 5, the reinforcing plate 3 does not require a molding die. Because of this, materials exhibiting outstanding adherability (mainly metal) can be selected for the reinforcing plate 3. Also, a flat shape does not produce any problem in bonding strength and a plate of a thickness smaller than the depth of the recessed groove 7 can be employed.

The optical pickup device using the optical pickup case having the above-described structures reached satisfactory results on long-term reliability of the bonding strength (peeling and axis deviation).

According to the embodiment, as described above, a recessed groove having a maximum length inside the optical pickup case is formed in a bonded connection of the optical pickup case. This makes it possible to provide an optical pickup device capable of inhibiting peeling from bonding interface and deviation of the optical due to long-term environmental variations.

### Second Embodiment

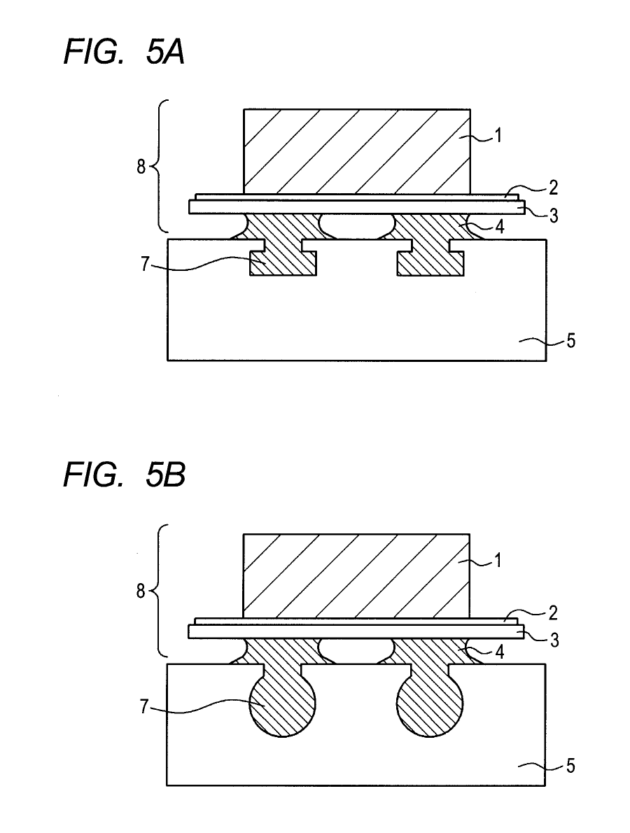

A second embodiment will be described with reference to FIGS. 5A and 5B. The matters described in the first embodiment but not described in the second embodiment can be applied to the second embodiment unless there is a specific reason. FIGS. 5A and 5B are top views of the bonded connections between the optics module 8 and the optical pickup case 5 in the optical pickup device according the embodiment. The optics module 8 includes the flexible printed substrate 2 connected to the light-receiving device 1 and the reinforcing plate 3 supporting the flexible printed substrate 2.

In the recessed groove in the optical pickup case, the bonding structure is formed such that the relationship between the opening length a of the recessed groove 7 and a longest length b of the bottom of the recessed groove becomes a<b. The configuration of the recessed groove is required to have the bonding structure in which the relationship a<b between the opening length a of the recessed groove 7 and a longest length b of the bottom of the recessed groove is achieved, even when the recessed groove is rectangular, circular, rhomboid or the like in cross section.

When the recessed groove is formed in a circular shape as shown in FIG. 5B, it produces the advantageous effect of facilitating the insertion of a needle used in the application of the adhesive into the recessed groove. The optical pickup device using the optical pickup case having the above-described structures reached satisfactory results on long-term reliability of the bonding strength (peeling and axis deviation).

Thus, according to the embodiment, the same advantageous effects as those in the first embodiment are produced.

### Third Embodiment

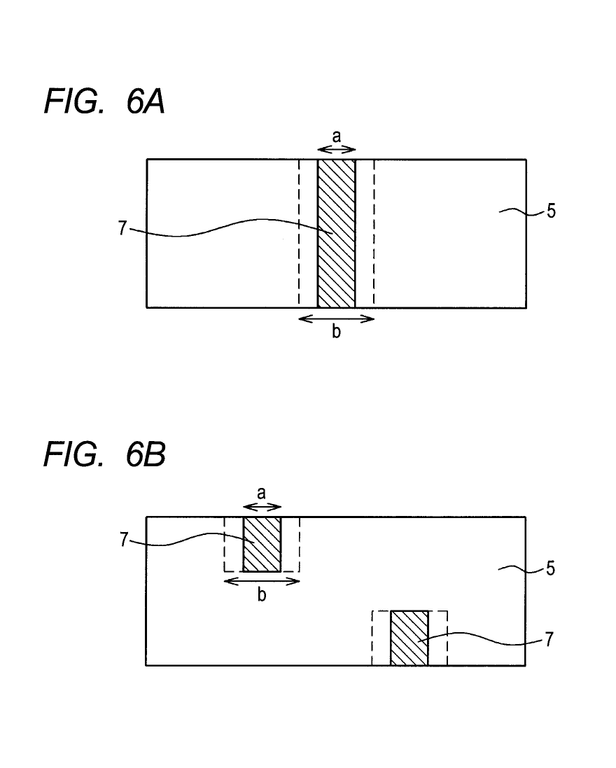

A third embodiment will be described with reference to FIGS. 6A and 6B. The matters described in the first or second embodiment but not described in the third embodiment can be applied to the third embodiment unless there is a specific reason. FIGS. 6A and 6B are side views of the optical pickup case in the optical pickup device according the embodiment. FIG. 6A shows an embodiment of a single recess groove serving as a bonding fixing area when the back surface of the optics module is bonded.

FIG. 6B shows an embodiment of two recessed grooves serving as a bonding fixing area when the back surface of the optics module is bonded, in which the two recessed grooves are formed respectively in upper and lower portions of optical pickup case in zigzag arrangement.

The optical pickup device using the optical pickup case having the above-described structures reached satisfactory results on long-term reliability of the bonding strength (peeling and axis deviation).

Thus, according to the embodiment, the same advantageous effects as those in the first embodiment are produced.

### Fourth Embodiment

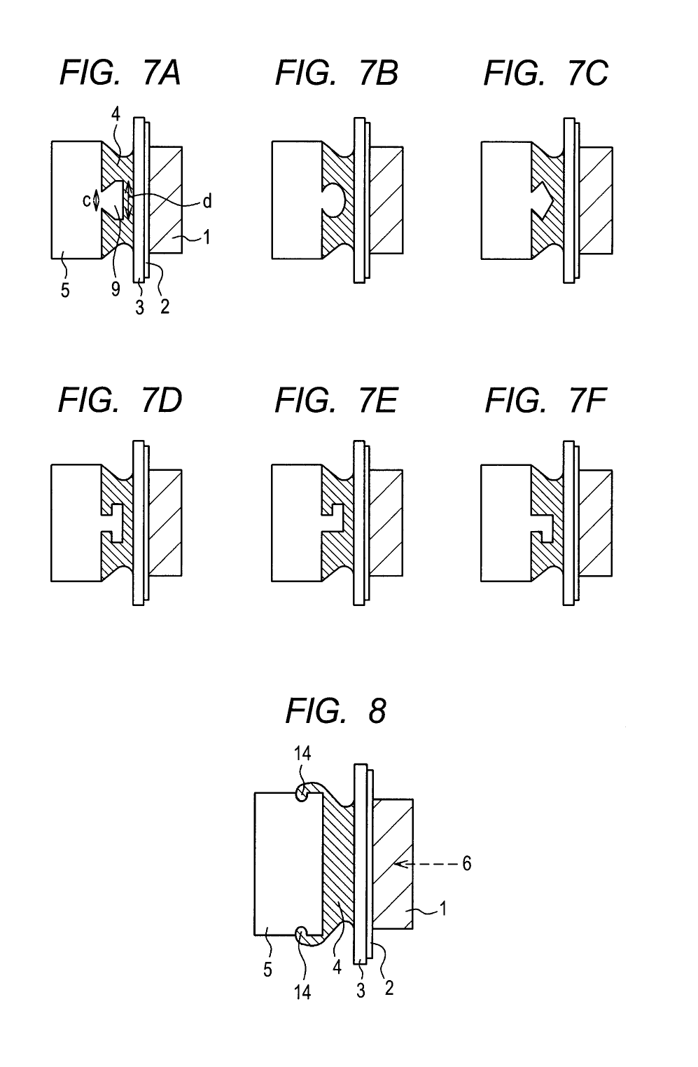

A fourth embodiment will be described with reference to FIGS. 7A to 7F. The matters described in any of the first to third embodiments but not described in the fourth embodiment can be applied to the fourth embodiment unless there is a specific reason. FIGS. 7A to 7F are sectional views of the bonded connection on the optics module in the optical pickup device according the embodiment, taken along the A-A′ line (corresponding to FIG. 3). In the optical pickup case 5, the opposed recessed grooves 7 which are the closed grooves are arranged in a direction perpendicular to the optical axis 6 extending toward the light-receiving device. The midway between the recessed grooves is the projection 9 for forming the closed grooves. FIG. 7A to FIG. 7D illustrate embodiments of the projection 9 designed in the relationship c<d in order to make it possible to prevent interface peeling from the optical pickup case 5 even when not only the moment in the shearing direction but also the moment in the tensile direction act.

When the projection 9 is designed to have c<d, the strength of the optical pickup case itself may possibly reduce depending upon the shape. In FIG. 7A, the bottom of the closed groove is sloped so as to achieve c<d. This makes it possible to maintain the strength of the optical pickup case itself.

In embodiments in FIGS. 7E and 7F, an upward projection and a downward projection shown respectively in FIGS. 7E and 7F are provided so as to achieve c<d. In this case, the same advantageous effects as those of the other embodiments are produced.

The optical pickup device using the optical pickup case having the above-described structures reached satisfactory results on long-term reliability of the bonding strength (peeling and axis deviation).

Thus, according to the embodiment, the same advantageous effects as those in the first embodiment are produced. Further, in the structure according to the first embodiment, the number of sides having the longest length inside the recessed groove is two, but it can be increased to three in the embodiment. This makes it possible to enhance the boding strength against a moment in the tensile direction.

### Fifth Embodiment

A fifth embodiment will be described with reference to FIG. 8. The matters described in any of the first to fourth embodiments but not described in the fifth embodiment can be applied to the fourth embodiment unless there is a specific reason.

FIG. 8 is a sectional view of the bonded connection on the optics module in the optical pickup device according to the fifth embodiment, taken along the A-A′ line (corresponding to FIG. 3). The fifth embodiment advantageously provides recessed grooves 14 formed in the optical pickup case and extending in a direction perpendicular to the optical axis 6 so that the adhesive can be hooked in the recessed grooves 14.

The optical pickup device using the optical pickup case having the above-described structure reached satisfactory results on long-term reliability of the bonding strength (peeling and axis deviation). Also, combination with the first to fourth embodiments makes a further enhancement in boding strength possible.

In this manner, according to the fifth embodiment, the same advantageous effects as those in the first embodiment can be produced. Also, the bonding strength can be further enhanced by combination with the structure of another embodiment.

It should be understood that the present invention is not limited to the aforementioned embodiments, and includes various modifications. For example, the foregoing embodiments have described in detail in order to provide a clear understanding of the present invention, and the present invention is not limited to one not necessarily including all the structures described above. A part of the structure of one embodiment can be substituted by the structure of any other embodiment, and the structure of one embodiment can be added to the structure of any other embodiment. An addition, a deletion, and/or substitution of the structure of one embodiment can be made on a part of the structure of another embodiment.

What is claimed is:

1. An optical pickup device, comprising:
a photonic device;
a flexible printed substrate connected to the photonic device;
a holding member supporting the photonic device and the flexible printed substrate;
an optical pickup case; and
an adhesive for bonding the holding member and the optical pickup case together,
wherein
the adhesive enters an inside of the optical pickup case, and
the adhesive has a cross-sectional area on the outer surface of the optical pickup case in communication with the inside, smaller than a cross-sectional area in the inside of the optical pickup case.

2. The optical pickup device according to claim 1, wherein
a bonding surface having faces of the photonic device and the holding member and the adhesive in the optical pickup case is provided along a thickness direction of the optical pickup case,
the optical pickup case has a groove formed in the bonding surface to allow the adhesive to flow into the groove.

3. The optical pickup device according to claim 2, wherein
the groove is a through groove extending through from a first face of the optical pickup case to a second face on the other side.

4. The optical pickup device according to claim 2, wherein
the groove has a first groove communicating with a first face of the optical pickup case and a second groove communicating with a second face on the opposite side to the first face which are independent of each other.

5. The optical pickup device according to claim 4, wherein
the first groove and the second groove are provided in the same position in a plane direction of the optical pickup case.

6. The optical pickup device according to claim 4, wherein
each of the first groove and the second groove has an end not opening onto the first or second face and having a recess that is made into the surface of the end toward the thickness direction of the optical pickup case in the inside of the optical pickup case.

7. The optical pickup device according to claim 3, wherein
the groove has a width extending perpendicular to the thickness direction of the optical pickup case in a direction included a plane direction of the bonding surface, and the width is increased inward from the surface of the optical pickup case in order for the adhesive to have the cross-sectional area on the outer surface of the optical pickup case in communication with the inside smaller than the cross-sectional area in the inside of the optical pickup case.

8. The optical pickup device according to claim 1, wherein
the holding member is made of metal and the optical pickup case is made of resin.

9. The optical pickup device according to claim 8, wherein
the bonding surface on which the holding member is bonded to the adhesive is nearly horizontal.
